(19) United States
(12) Patent Application Publication
(10) Pub. No.: US 2005/0242777 A1
(43) Pub. Date: Nov. 3, 2005

(54) Charger for rechargeable batteries

(75) Inventors: Johann Reiner Godefridus Cornelis Maria Van Beek, Eindhoven (NL); Petrus Henricus Laurentius Notten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/517,537

(22) PCT Filed: May 27, 2003
(86) PCT No.: PCT/IB03/02310

§ 371 Date: Dec. 10, 2004

(30) Foreign Application Priority Data
Jun. 14, 2002 (EP) 02077383.4

(51) Int. Cl. H02J 7/00

(52) U.S. Cl. 320/128

(57) ABSTRACT

A battery charger (1) for charging rechargeable batteries (5) and/or battery packs is disclosed. Preferably the charger (1) can apply two modes of charging a battery. In a normal charging mode a battery is charged to full capacity at a relatively low rate. In a boost charging mode the battery is charged very rapidly and only to maximally 80% of its full capacity. The boost-charging mode makes it possible to provide some charge to the battery (5) when the time available for charging is limited. Due to the partial charging a much higher charging current than allowed at normal charging may be applied during boost charging.

The present invention relates to a method of charging a rechargeable unit, such as a rechargeable battery or a rechargeable battery pack.

The present invention also relates to a charger for charging a rechargeable unit, such as rechargeable battery or a rechargeable battery pack, said charger comprising a supply unit for supplying charging current to a rechargeable unit.

Rechargeable batteries and rechargeable battery packs have a wide spread use in the modern life. Many apparatuses, such as mobile phones, battery operated electric shavers, battery powered vehicles, electrical tools etc, are equipped with such batteries.

The rechargeable batteries and battery packs need to be recharged every now and then. There are several types of chargers that can be used for recharging rechargeable batteries. A common type of charger employs a constant current level (CC) throughout the whole charging process of the battery. Fast chargers of this type employ a high, constant current until the battery is fully charged. An electronic unit in the charger is used to detect end-of-charge and cut off the charging current.

The above-mentioned CC-charger is useful for charging e.g. NiCd (Nickel-Cadmium) and NiMH (Nickel-Metal-Hydride) batteries. With these batteries the end-of-charge state can be detected as a sudden increase in the temperature of the battery and as a drop in the terminal voltage of the battery.

Lithium batteries (including lithium-ion, lithium-polymer and lithium solid state batteries) cannot be charged by fast chargers of the type mentioned above, since lithium batteries do not provide the above-described indications of end-of-charge and since the maximum voltage has to be controlled to avoid damage to the lithium batteries.

U.S. Pat. No. 5,994,878 assigned to Ostergaard et al. describes a charger that can handle different types of batteries, including lithium batteries. The charger may first charge the battery in a constant current mode and then in a constant voltage mode (constant current then constant voltage charging=CCCV). During the first phase of the charging process the charger is in a constant charging current control mode. The charging current is controlled at a preset level and the charging voltage is monitored. When the charging voltage reaches a certain, preset level the charging process enters a constant charging voltage control mode. In this mode the charging voltage is held substantially constant while the charging current is reduced. The charging process as described in U.S. Pat. No. 5,994,878 is however slow and will not allow quick charging of a battery.

An object of the present invention is to provide a charging method that makes it possible to quickly add capacity to rechargeable units.

A further object of the invention is to provide a charger that makes it possible to quickly add capacity to rechargeable units.

A charging method according to the preamble is characterized in that a charging current corresponding to more than 2 C-rates is supplied to the rechargeable unit, and that the supply of charging current is interrupted before the rechargeable unit has been charged to maximally 80% of its full capacity.

It has been found that the interruption of the charging process when the rechargeable unit is partially charged makes it possible to increase the charging current substantially as compared to prior art chargers without any risk of damaging the rechargeable unit. The invention thus provides for very quick partial charging of a rechargeable unit. A typical situation where this has very material advantages is when a user who is just about to leave his home finds out that the battery of e.g. the mobile phone or the shaver is empty. By charging just a few minutes according to the method described above, the person may obtain sufficient battery charge for his needs in e.g. one day. Another example is hybrid electrical vehicles H(EV) and in particular electrical vehicles. A user who finds the batteries of the vehicle empty may in a very short period of time give the batteries a charge that is sufficient for the ride home.

The measure as defined in claim 2 has the advantage that a rechargeable unit may be fully charged very quickly. The first charging sequence, i.e. charging at a current of more than 2 C-rates to maximally 80% of the full capacity, is very rapid. After this sequence has been interrupted a second sequence in the form of a normal charging process is started. The normal charging process is slow, but since the rechargeable unit was partially charged at a very high rate the overall time necessary to fully charge the rechargeable unit is considerably shorter than with prior art charging methods.

The measure as defined in claim 3 has the advantage that extremely quick, partial charging is possible. Such charging is preferable when the charging time is very limited.

The measure as defined in claim 4 has the advantage that a fully or almost fully charged battery or battery pack is not charged according to the invention. Thus the risk of damaging the battery is substantially eliminated.

A charger according to the preamble is characterized in that the charger further comprises:
means for supplying a charging current of more than 2 C-rates to the rechargeable unit; and
means for interrupting charging before the rechargeable unit has been charged to maximally 80% of its full capacity.

The charger described above will provide for very quick partial charging of a rechargeable unit without the risk of damaging said unit.

The measure as defined in claim 6 has the advantage that the user of the charger can choose the charging mode that suits the present situation. If the user is in a hurry he chooses boost charging, e.g. by pushing a corresponding button. If there is plenty of time for charging, the person pushes another button to choose normal charging.

The measure as defined in claim 7 has the advantage that the charger may be utilized also for fast full charging of a battery. Since normal charging, in this case charging the battery from partial to full capacity, occurs at a low C-rate the battery is not damaged during any part of the charging process.

The measure as defined in claim 8 has the advantage that the charger can be used for both partial charging and full charging. After interrupting the high rate partial charging, the charger automatically shifts to slow rate normal charging to finalize the charging of a battery. The charger could thus be used both when the user quickly wants some capacity added to a battery and when the user wants to fully charge the battery. No control buttons are necessary since the user could terminate the charging process at any moment in time by just cutting off the supply of charging current, e.g. by disconnecting the shaver from the mains socket.

The measure as defined in claim 9 has the advantage that the user becomes aware that fast charging is terminated and that the battery is partially charged and ready for use. The user may then choose to interrupt the charging process or allow it to proceed in a normal charging mode.

The measure according to claim 10 provides a simple way of interrupting the charging process. A timer function is cheap and simple to include in a control unit controlling charging and provides a safe way of interrupting the charging process well before the high charging current causes any damage to the rechargeable unit. The timer function is pedagogic in that it makes the charging method easy to use and understand for the end user.

These and other aspects of the invention will be apparent from and elucidated with reference to the embodiments described hereafter.

The invention will hereafter be described in more detail and with reference to the appended drawings.

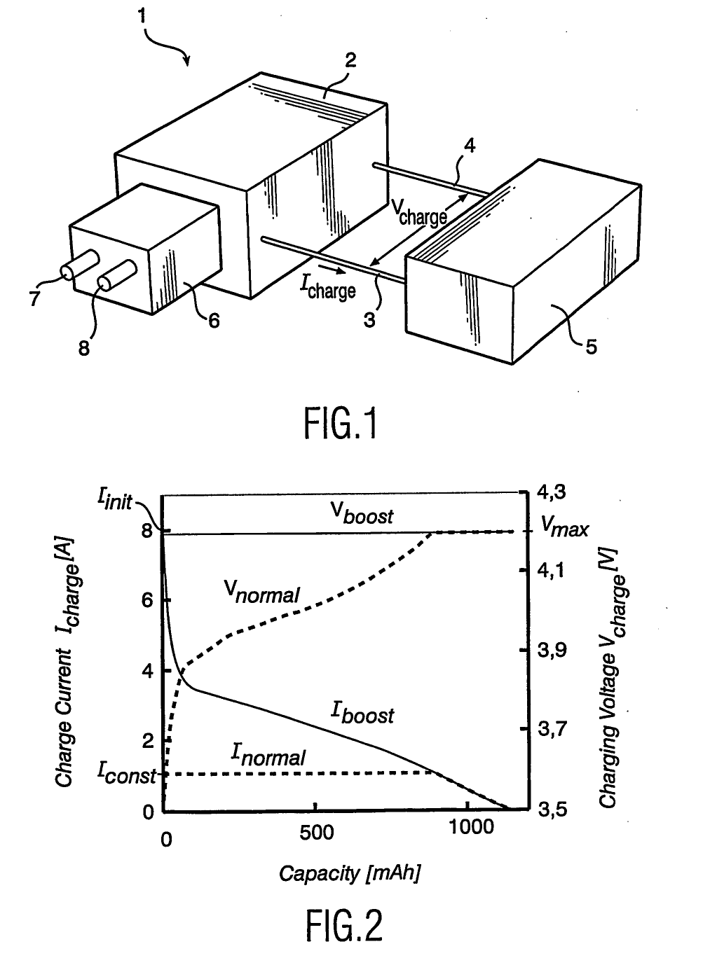

FIG. 1 is a schematic drawing of a charger according to the invention.

FIG. 2 is a diagram showing the charging principles of boost charging and normal charging.

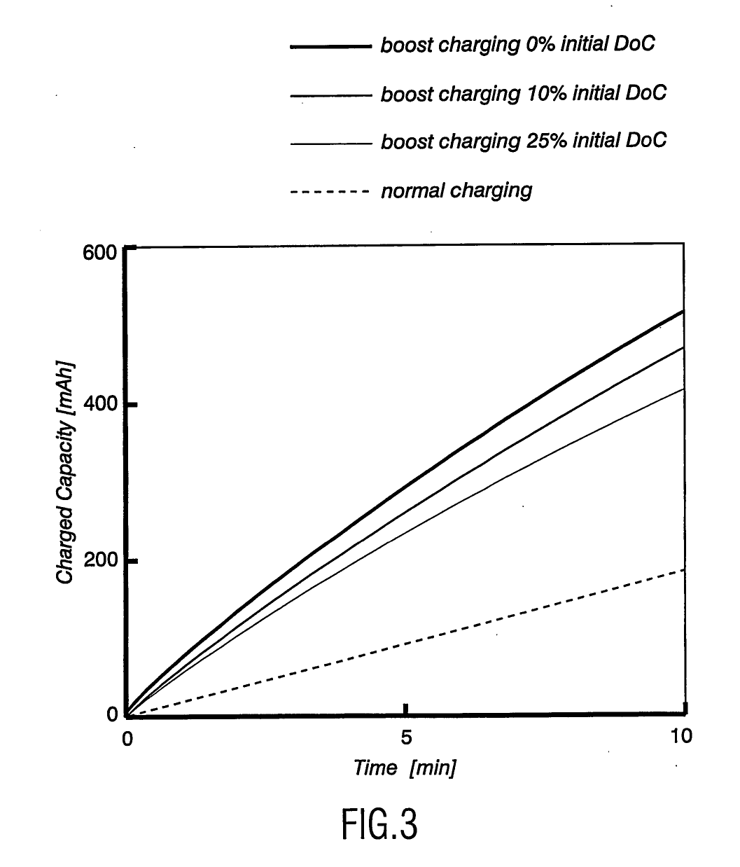

FIG. 3 is a diagram showing the capacity growth of a battery during boost charging and during normal charging.

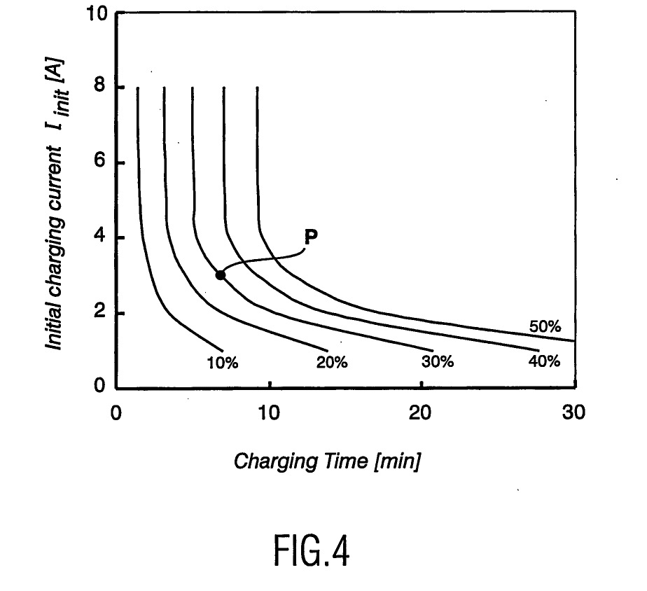

FIG. 4 is a diagram showing the charging times for an empty battery at different initial charging currents and different final depths of charge.

The expression C-rate is often used when discussing the charging of batteries. 1 C-rate is the charging current that would be needed to charge an empty battery to its maximum capacity in 1 hour. For each battery capacity a certain C-rate means a certain current.

The expression “boost charging” as used in the present application means a charging method for quickly adding capacity to a battery by charging it.

The expression “normal charging” as used in the present application means a charging method for charging, at a rather slow rate, a battery to its maximum capacity.

The term “cycle life” as used in the present application refers to the number of times a battery can be recharged before it has to be disposed of. A long cycle life means that the battery can be recharged many times.

In the present application “depth of charge” (DoC) refers to the charged capacity of a battery or battery pack. A DoC of 100% means that the battery has been charged to its maximum capacity.

In FIG. 1 a preferred embodiment of the invention in the form of a battery charger 1 is shown. The battery charger 1 has a charge current supply unit 2 adapted to supply a desired voltage and current. Terminals in the form of electric cables 3, 4 connect the charger 1 to a battery 5 that is to be charged. Preferably the cables 3, 4 are each split up into a current lead and a sense lead for sensing the voltage. The battery charger 1 has a control unit 6 that controls the current and the voltage supplied by the supply unit 2 to the battery 5. The control unit 6 is provided with a selector comprising a first control button, schematically indicated as 7 in FIG. 1, for activating normal charging of the battery 5. The selector further comprises a second control button, schematically indicated as 8 in FIG. 1, for activating boost charging of the battery 5.

Normal charging is activated when the user of the charger 1 pushes the normal charging button 7. Normal charging of the battery 5 is preferably performed according to the constant current/constant voltage method (CCCV-method) or at a constant current level (CC-method) depending on the type of battery to be charged. With the CC-method the current may be supplied in pulses of substantially the same current.

With the CCCV-method, which is often employed for charging lithium batteries, the control unit 6 controls the supply unit 2 such that the battery 5 is first charged in accordance with a constant current mode (CC-mode) while monitoring the voltage (i.e. the voltage as measured between cable 3 and 4). The constant current I_{const} during the CC-mode is typically set low such that an empty battery will obtain about 50-90% of its nominal max capacity during the CC-mode. A typical constant current I_{const} for a lithium battery would be 0.7 C-rate, that is a current that, if held constant during 1 hour, would charge the battery to 70% of its maximum capacity. When the voltage reaches after some time the prescribed maximum voltage Vₘₐₓ the control unit 6 changes to a constant voltage mode (CV-mode). During the CV-mode the current supplied by the supply unit 2 is controlled such that the voltage is kept constant at Vₘₐₓ while the current is allowed to decrease. The control unit 6 stops the charging process when the current has been decreased to a small value or after a predetermined time interval that is sufficient for fully charging the battery. The battery thus charged to its maximum capacity in a slow and cautious manner is ready for use. The normal charging process provides for a long cycle life of the battery and a fully charged battery.

With the CC-method, which is often employed for charging NiMH and NiCd batteries, a constant current level (which may mean a pulsed current) is supplied to the battery throughout the charging process. Charging is interrupted when a detection method indicates that the battery is fully charged. One such detection method is temperature measurement. The temperature of the battery is measured and when it exceeds a certain temperature the battery is fully charged. Another detection method is measurement of voltage change over time (dV/dt). When a voltage decrease is detected the battery is fully charged and charging is interrupted. The constant charging current during this type of charging of a NiMH battery is maximally about 1 C-rate, since a higher charging current may cause oxygen formation in the battery followed by an increased gas pressure. NiCd batteries are charged at maximally 2 C-rates for the same reason. RAM batteries are charged at charging currents below 1 C-rate.

Boost charging of the battery 5 is activated when the user of the charger 1 pushes the boost charging button 8. Boost charging of the battery 5 is performed according to the method of the present invention.

In the case of boost charging of lithium batteries the control unit 6 controls the supply unit 2 such that a very high initial current Iᵢₙᵢₜ is immediately supplied to the battery 5. The control unit 6 monitors the voltage supplied (i.e. the voltage as measured between cable 3 and 4) and controls the current such that the voltage is kept at the prescribed maximum voltage Vₘₐₓ. The initial current Iᵢₙᵢₜ is chosen such that the maximum voltage Vₘₐₓ is reached almost immediately. The control unit 6 will thus control the current supplied to the battery 5 such that the current is immediately, or after a very short period of time, decreased from Iᵢₙᵢₜ to a lower value. If Iᵢₙᵢₜ is very high there will be no constant current phase at all. At a somewhat lower Iᵢₙᵢₜ, still being very high in relation to the current I_{const} supplied during the CC-mode of the normal charging process, a short period of time may elapse before the current is decreased. In either case there is no constant current phase of the type described in relation to normal charging.

It has been found that the initial charging current Iᵢₙᵢₜ applied in the case of boost charging of lithium batteries should be higher than 1 C-rate, i.e. a current that, if held constant, would charge an empty battery to 50% of its maximum capacity in less than 30 minutes, to provide quick charging. Initial currents Iᵢₙᵢₜ higher than 2 C-rates, still more preferably higher than 3,5 C-rates, have been found to provide a substantial further reduction of the charging time. It has been found that the initial charging current Iᵢₙᵢₜ should be chosen such that, at the start of charging, the predetermined maximum charging voltage is reached in not more than 2 minutes, since charging during the first minutes should be performed at a voltage that is as high as possible to decrease the time of charging. It has also been found that the initial charging current Iᵢₙᵢₜ should preferably be chosen such that the maximum charging voltage is reached in not more than 30 seconds, and still more preferably in not more than 5 seconds, to provide a further substantial reduction of the charging time, charging during the first minute being most efficient if performed at a high current and maximum voltage, still without substantial detrimental effects on the cycle life.

With other types of batteries, such as NiMH and NiCd, boost charging is preferably performed at a constant current level, which could be a pulsating current or a truly constant current. The charging current is higher than that allowed in normal charging due to the fact that boost charging is partial charging. The current in the case of boost charging of NiCd and NiMH batteries is more than 2 C-rates and more preferably more than 4 C-rates.

It has been found that boost charging should be interrupted when the battery 5 has been charged to maximally 80% of its maximum capacity (i.e. 80% DoC) to provide quick charging without substantial negative effects on the cycle life. At very high charging currents, such as charging currents corresponding to 8 C-rates and higher, the charging is preferably interrupted at a DoC of maximally 60% to avoid damage to the battery, such as excessive generation of heat or gas in the battery. Such charging would very quickly add capacity to the battery and could be used when the user only has a few minutes available. It has further been found that an interruption of the charging process at a battery DoC of 10-60% provides a relation between time of charging and charged capacity that is attractive for most users of the boost charging function. Thus boost charging is preferably used for quick, partial charging of the battery. To stop boost charging at the proper time for partial charging, preferably a function for measuring the DoC, i.e. the DoC of the battery at a certain time, is included in the control unit 6. The DoC can be measured by measuring battery parameters according to one of several methods that are well known to the skilled person. Examples of such methods of measuring a battery parameter for relating it to the DoC of a battery include open circuit voltage (OCV) measurement and resistance free voltage (RFV) measurement.

The application of boost charging is preferably restricted such that a battery that already has full capacity or almost full capacity cannot be subjected to boost charging. The control unit 6 thus preferably includes a function for measuring the DoC, i.e. the initial DoC, of a presumably empty battery 5 before any charging, and in particular any boost charging, may start. To measure the DoC of a battery before starting the charging process use can be made of one of several methods that are well known to the skilled person. Examples of such methods of measuring a battery parameter for relating it to the DoC of a battery includes open circuit voltage (OCV) measurement, resistance free voltage (RFV) measurement and battery voltage after relaxation (Vᵣₑₗₐₓ). When charging lithium batteries it is also possible to measure the DoC at the very beginning of the charging process by measuring the time elapsed before the charging current starts to decrease, provided that the initial current Iᵢₙᵢₜ is chosen such that a short period of time elapses before the current needs to be decreased to avoid exceeding the maximum charge voltage. The shorter the time before the charging current is decreased, the higher the initial DoC is. Another alternative available when charging lithium batteries is to measure the slope of the voltage increase over time when starting boost charging, i.e. measure dV/dt. A large dV/dt then indicates a high initial DoC of the battery. If the measurement of the time elapsed before charging current decreases, or of the dV/dt, reveals that the battery already has a high or full capacity, boost charging is immediately interrupted.

In addition to the detrimental effect on the cycle life, the time gained by boost charging at a high initial DoC is so low that it is preferably avoided. Boost charging should not be started, or, if in an early phase, stopped immediately, if the battery is found to have an initial DoC of more than 70% to avoid detrimental effects on the cycle life. The charger 1 may be equipped with a function, such as a flashing light or a sound, for indicating that boost charging is interrupted due to high initial DoC, thus showing the user that the battery already has a certain charge. It has further been found that the relation between time of charging and charged capacity has a negative effect on the advantages of starting a boost charging process at an initial DoC of more than 50%.

In a further example of controlling the charging process a timer function is provided in the control unit 6. The timer is set to allow boost charging during a certain time, e.g. 5 or 10 minutes, and then interrupt charging. The timer may be combined with the above described function for avoiding charging at high initial DoC and/or the function for interrupting charging at a certain, predetermined DoC. The timer function makes the boost charging function easy to use and understand for the end user.

The control unit may also be adopted to allow boost charging for some time and then switch to normal charging. In such a case the battery is first charged at a high rate for a certain time or to a certain DoC. The charger then switches to normal charging and allows charging of the battery to proceed at a low rate until the battery is fully charged. Preferably an indication, such as the switching on of a light, e.g. a LED, or the sounding of a speaker, is used to indicate that boost charging is finalized. The user may then choose to interrupt the charging or allow it to proceed in the normal charging mode for fully charging the battery at a slow rate.

Boost charging may be applied to all types of rechargeable batteries. Examples of such batteries include nickel metal hydride batteries (NiMH), nickel cadmium batteries (NiCd), lead acid batteries (Pb-acid), rechargeable alkaline manganese batteries (RAM) and lithium batteries. Boost charging has been found to be particularly advantageous for lithium batteries, including lithium ion batteries (Li-ion), lithium polymer batteries (Li-polymer), lithium polymer gel batteries (Li-polymer gel) and lithium-metal batteries (Li-metal), since lithium batteries must not be charged at high voltages. Due to this fact, chargers for quick charging of lithium batteries did not exist hitherto.

The charger according to the invention may be a stand-alone charger or an integral charger. Thus the charger may be an integral part of any electronic or battery driven apparatus. Examples of such an electronic apparatus incorporating a charger are shavers, mobile phones, battery packs, electrical vehicles, hybrid electrical vehicles H(EV), and personal computers. In the case of integral chargers a selector is preferably located at the housing of the apparatus, such as a shaver, to allow the user to choose the charging mode.

A number of tests were performed to demonstrate the effectiveness of the charger according to the invention. In the tests a Li-ion battery in the form of a standard Sony US18500 cell with a nominal capacity of 1100 mAh was used. All tests were performed at 25° C.

FIG. 2 shows the boost charging and normal charging process. The left vertical axis of FIG. 2 is the charge current I_{charge} in Amperes, the right vertical axis is the charging voltage V_{charge} in Volts and the horizontal axis is the charged battery capacity in mAh. Normal charging (dotted lines in FIG. 2) takes place at a constant current I_{const} of about 1 A until the battery has obtained about 80% of its maximum capacity. The control unit 6 comprises a charge current limiting function which increases the charge current from zero to the predetermined constant charging current I_{const} and then prevents the charging current from increasing any further. During this phase of constant current (CC) charging the charging voltage increases slowly from 3.6 to 4.2 V, which is the maximum charging voltage of this cell. When the charging voltage reaches 4.2 V the charger switches to constant voltage mode. Thus the cell is charged with the last 20% of its capacity at a constant voltage of 4.2 V and a decreasing current.

Boost charging is illustrated by means of solid lines in FIG. 2. At the start of the boost charging process, an initial current Iᵢₙᵢₜ of 8 A is supplied to the cell. The charge voltage increases immediately, i.e. in less than 1 second, to the maximum charge voltage of 4.2 V. The control unit decreases the charging current such that the charging voltage is maintained at 4,2 V. The charging current first decreases rapidly, within 1 minute, to about 4 A. The charging current then decreases further at a slower rate.

As is indicated in FIG. 2, charging at the end of the charging procedure, i.e. the charging of the final 20% of the charging capacity, is similar for normal charging and boost charging. Thus it can be concluded that the impact of the high initial charging current on the charge build up is small.

In FIG. 3 the capacity build up as a function of time is shown. The vertical axis is the charged capacity, i.e. the capacity added to the battery during charging, in mAh and the horizontal axis is the time in minutes. The maximum charging voltage was 4.2 V. The dotted line describes the build up of charge in an empty battery using normal charging. After normal charging for 10 minutes the DoC of the battery has increased to about 16% of its maximum capacity. The constant current during the 10 minutes of normal charging was about 1 A corresponding to 1 A/1100 mAh=0,9 C-rates. Three tests were carried out with boost charging using an initial current Iᵢₙᵢₜ of 8 A corresponding to an initial C-rate of 8 A/1100 mAh=7,3 C-rates. The results of boost charging of an empty battery (0% initial DoC) and batteries with 10 and 25% initial DoC are shown by means of solid lines in FIG. 3. The empty battery obtained almost 50% of its maximum capacity after only 10 minutes of boost charging. The batteries that had an initial DoC of 10% and 25% respectively showed a somewhat slower capacity build up compared to the charging of the empty battery. However, as shown in FIG. 3, the capacity build up at boost charging was in all cases considerably quicker than capacity build up at normal charging.

In FIG. 4 the impact of the initial charging current Iᵢₙᵢₜ on the charging of an empty battery (0% initial DoC) to a certain DoC is demonstrated. The vertical axis is the initial charging current Iᵢₙᵢₜ in Amperes and the horizontal axis is the charging time in minutes. The curves denote the different DoC, 10-50%, at which charging is interrupted. Thus the 30% curve represents the time it takes to charge an empty battery to a DoC of 30% of its maximum capacity at different initial currents Iᵢₙᵢₜ. The point P represents, by way of example, that, at an initial current Iᵢₙᵢₜ of 3 A, a DoC of 30% is reached after 6.9 minutes.

It is evident from FIG. 4 that an initial charging current Iᵢₙᵢₜ above 4 A, corresponding to an initial C-rate of about 3.6 C-rates, does not further decrease the time required to obtain a certain DoC. On the other hand an initial charging current below 2 A, corresponding to an initial C-rate of about 1.8 C-rates, results in a substantial increase of the time required to obtain a certain DoC.

A test was performed at a maximum charging voltage higher than the allowed 4.2 V. The maximum charging voltage was thus set to 4,3 V. It was found that an empty battery (0% initial DoC) was charged to a DoC of almost 50% at an initial charging current Iᵢₙᵢₜ of 8 A in 8 minutes which is two minutes less than the 10 minutes required at 4.2 V (see FIG. 3).

Finally, to summarize, a battery charger 1 for charging rechargeable batteries 5 and/or battery packs is disclosed. Preferably the charger 1 can apply two modes of charging a battery. In a normal charging mode a battery is charged to full capacity at a relatively low rate. In a boost charging mode the battery is charged very rapidly and only to maximally 80% of its full capacity. The boost-charging mode makes it possible to provide some charge to the battery 5 when the time available for charging is limited. As a result of partial charging, a much higher charging current than that allowed at normal charging may be applied during boost charging.

1. A method of charging a rechargeable unit, such as a rechargeable battery or a rechargeable battery pack, characterized in:
that a charging current corresponding to more than 2 C-rates is supplied to the rechargeable unit; and
that the supply of charging current is interrupted before the rechargeable unit has been charged to maximum 80% of its full capacity.

2. A method according to claim 1, wherein said charging is followed by normal charging proceeding at a current corresponding to maximally 1 C-rate until the rechargeable unit is substantially fully charged.

3. A method according to claim 1, wherein a charging current of more than 4 C-rates is used for charging a rechargeable unit comprising an NiCd or an NiMH battery.

4. A method according to claim 1, wherein a measurement of the initial capacity of the rechargeable unit is made before charging starts or at the beginning of the charging process, the supply of charging current being stopped if the initial capacity is found to be higher than a predetermined initial capacity.

5. A charger for charging a rechargeable unit, such as a rechargeable battery or a rechargeable battery pack, comprises a supply unit for supplying charging current to a rechargeable unit, characterized in that the charger further comprises:
means for supplying a charging current of more than 2 C-rates to the rechargeable unit; and
means for interrupting charging before the rechargeable unit has been charged to maximally 80% of its full capacity.

6. A charger according to claim 5, wherein the charger further comprises a manual selector for choosing between:
a boost charging mode wherein the rechargeable unit is charged to maximum 80% of its maximum capacity at a current corresponding to more than 2 C-rates; and
a normal charging mode wherein the rechargeable unit is fully charged at a current corresponding to maximum 1 C-rate.

7. A charger according to claim 6, wherein the charger comprises means for switching from the boost charging mode to the normal charging mode when the rechargeable unit has been charged to maximally 80% of its full capacity.

8. A charger according to claim 5, wherein the charger comprises means for automatically switching to a normal charging mode for charging the rechargeable unit to full capacity at a current corresponding to maximally 1 C-rate after said interruption of said charging process.

9. A charger according to claim 5, wherein the charger comprises means, such as an LED or a speaker, for providing an indication to the user of the charger that said interruption of said charging process has occurred.

10. A charger according to claim 5, wherein the charger comprises a timer unit, the timer unit being devised to interrupt said charging process after a predetermined time interval.
